(19) United States
(12) Patent Application Publication
(10) Pub. No.: US 2013/0258503 A1
(43) Pub. Date: Oct. 3, 2013

(54) OPTICAL LENS ASSEMBLY AND A LASER WELDING METHOD USED FOR THE SAME

(71) Applicant: Chun-Yi Lu, Taichung (TW)

(72) Inventor: Chun-Yi Lu, Taichung (TW)

(73) Assignee: LARGAN PRECISION CO., LTD, Taichung (TW)

(21) Appl. No.: 13/493,282

(22) Filed: Jun. 11, 2012

(30) Foreign Application Priority Data
Apr. 3, 2012 (TW) 101111794

(51) Int. Cl. G02B 7/02; B23K 26/00

(52) U.S. Cl. 359/819; 219/121.64

(57) ABSTRACT

The present invention provides an optical lens assembly, comprising: at least an optical lens; a lens barrel within which the at least one optical lens is placed; and a retainer placed within the lens barrel; wherein the optical lens is arranged such that an optical axis thereof is aligned with a central axis of the lens barrel; and wherein the retainer is arranged such that a peripheral surface thereof is in contact with an inner wall of the lens barrel and a bottom surface thereof is pressed against one surface of the optical lens. A laser beam is used to irradiate the peripheral surface of the retainer to cause a temperature rise at an area where the retainer is in contact with the lens barrel to reach a welding temperature, thereby welding the retainer to an inner side of the lens barrel.

### BACKGROUND OF THE INVENTION

1. Field of the Invention

The present invention relates to an optical lens assembly and a laser welding method for the same which are applicable to camera modules or photographing modules equipped in handheld devices such as Tablet PCs, mobile phones or Personal Digital Assistants (PDAs).

2. Description of the Prior Art

Today, most portable devices are equipped with a photographing function for which an optical lens assembly is essential and indispensable. FIG. 6 is a schematic representation of a prior art optical lens assembly 60. The optical lens assembly 60 at least comprises an optical lens 61, a lens barrel 62 and a lens holder 63. The optical lens 61 is fixed to an inner wall of the lens barrel 62 through the application of an adhesive 64 between the optical lens 61 and the lens barrel 62. One of the drawbacks, however, is that the application of the adhesive takes longer because the position between the optical lens 61 and the lens barrel 62 at which the adhesive is to be applied is a slit and the adhesive is usually in form of a thick fluid. After the adhesive 64 has been applied, a curing apparatus is required to cure the adhesive 64 for a period of time. Consequently, it takes longer to produce an optical lens assembly and results in lower production efficiency. Another drawback is that the viscosity level of the adhesive 64 falls gradually over time because of degradation. When the viscosity level of the adhesive 64 degrades over time, the optical axis of the optical lens will not be in alignment with that of the lens barrel. As a result, the life span of the optical lens assembly will be shortened. Yet another drawback is that the entire rigidity of the optical lens assembly is not satisfactory due to the use of adhesive.

Therefore, a need exists in the art for an optical lens assembly characterized in that its lens can be securely fixed inside the lens barrel, that the production efficiency is high and that the entire rigidity of the optical lens assembly is enhanced to prevent misalignment of optical axes caused due to the long term usage of the optical lens assembly.

### SUMMARY OF THE INVENTION

To accomplish the aforementioned objects, the present invention provides an optical lens assembly, comprising: an optical lens; a lens barrel inside which the optical lens is disposed; and a retainer comprising a bottom surface against which a surface of the optical lens abuts and disposed at and laser welded to the inner side of the lens barrel. As the optical lens and the retainer of the present invention are fixed through a laser welding method, the high peak rate of a laser beam causes minor deformation of the welding area struck by the laser beam. As the extent of deformation of the optical lens, the retainer and the lens barrel is very small, the optical lens can be fixed precisely at a predetermined position inside the lens barrel with its optical axis in alignment with a central axis of the lens barrel and held securely between the retainer and the lens barrel. Therefore, the present invention can provide a securely assembled optical lens assembly capable of producing a satisfactory and deformation-free image.

Preferably, the retainer has a serrated or undulating surface so as to provide a larger laser energy receiving surface, thereby increasing the reliability of the optical lens assembly after the welding operation has been performed.

Preferably, the retainer and the lens barrel are both made of black plastic material so that the light absorbing efficiency of the laser welding area can be increased.

According to another mode of the present invention, there is provided an optical lens assembly comprising: an optical lens; a lens barrel inside which the optical lens is disposed; and a retainer comprising a bottom surface against which a surface of the optical lens abuts and disposed at and laser welded to the inner side of the lens barrel, and characterized in that the retainer is made of an infrared penetrable material. When a surface of the retainer is irradiated by a laser beam (e.g. an infrared laser beam), the energy of the laser beam penetrates the retainer and accumulates in the area where the retainer is in contact with the inner side of the lens barrel, thereby a temperature at the area increases to a welding temperature to weld the retainer to the inner side of the lens barrel. With the aforementioned arrangement, the size of the area where the retainer and the lens barrel are welded together is increased and the laser beam can be projected to the surface of the retainer from any direction.

According to another mode of the present invention, there is provided an optical lens assembly comprising: an optical lens; a lens barrel inside which the optical lens is disposed; and a retainer comprising a bottom surface against which a surface of the optical lens abuts and disposed at and laser welded to the inner side of the lens barrel, and characterized in that the lens barrel comprises an infrared passable portion (see FIG. 4) made of an infrared penetrable material.

The retainer is fixed to the lens barrel at a position corresponding to the infrared passable portion. When the infrared passable portion of the lens barrel is irradiated by a laser beam (e.g. an infrared laser beam), the energy of the laser beam will not accumulate on the lens barrel. Instead the energy penetrates the infrared passable portion and accumulates on the retainer located at the inner side of the lens barrel, thereby a temperature at the area of the retainer irradiated by the laser beam increases to a welding temperature to enable the retainer to be fixed to the inner side of the lens barrel.

According to another mode of the present invention, there is provided an optical lens assembly comprising: at least one optical lens and a lens barrel inside which the optical lens is disposed. As the optical lens is penetrable by light, energy will penetrate the optical lens and accumulates in the area where the optical lens is in contact with the inner side of the lens barrel when a surface of the optical lens is irradiated by a laser beam. After a temperature at the area increases to a welding temperature, the outer periphery of the optical lens is welded to the inner side of the lens barrel. With the aforementioned arrangement, any area where the optical lens is in contact with the lens barrel can serve as a welding area that enables the optical lens and the lens barrel to be directly welded together, and the laser beam can be projected to the surface of the optical lens from any direction. Consequently, the manufacturing process is simplified and the production efficiency is increased.

The present invention provides a laser welding method for an optical lens assembly, comprising: providing an optical lens, a lens barrel and a retainer; placing the optical lens inside the lens barrel with an optical axis of the optical lens aligned with a central axis of the lens barrel; placing the retainer inside the lens barrel with a peripheral surface of the retainer in contact with an inner wall of the lens barrel and a bottom surface of the retainer pressed against a surface of the optical lens; irradiating the peripheral surface of the retainer with a laser beam to cause a temperature at an area where the retainer is in contact with the lens barrel to reach a welding temperature and thereby to weld the retainer to an inner side of the lens barrel.

The present invention provides another laser welding method for an optical lens assembly, comprising: providing an optical lens and a lens barrel; placing the optical lens inside the lens barrel with an optical axis of the optical lens aligned with a central axis of the lens barrel; irradiating an area where the optical lens is in contact with the lens barrel with a laser beam to cause a temperature at the area to reach a welding temperature and thereby to fix the optical lens to an inner side of the lens barrel.

The aforementioned and other objects and characteristics of the present invention will be better understood by reference to the appended drawings, in which preferred embodiments of the present invention are shown.

### BRIEF DESCRIPTION OF THE DRAWINGS

FIG. 1A is an exploded view of an optical lens assembly in accordance with a first embodiment of the present invention.

FIG. 1B is an enlarged partial view of a retainer shown in FIG. 1A.

FIGS. 2A and 2B each illustrates a sectional view and an enlarged partial view of the optical lens assembly in accordance with the first embodiment of the present invention.

FIG. 3 is a sectional view of an optical lens assembly in accordance with a second embodiment of the present invention.

FIG. 4 illustrates a sectional view and an enlarged partial view of an optical lens assembly in accordance with a third embodiment of the present invention.

FIG. 5 is a sectional view of an optical lens assembly in accordance with a fourth embodiment of the present invention.

FIG. 6 is a schematic representation of a prior art optical lens assembly.

### DETAILED DESCRIPTION OF THE PREFERRED EMBODIMENTS

The preferred embodiments of the present invention will be described by reference to the appended drawings. Unless otherwise defined herein, the same components in different drawings are denoted by the same reference numerals.

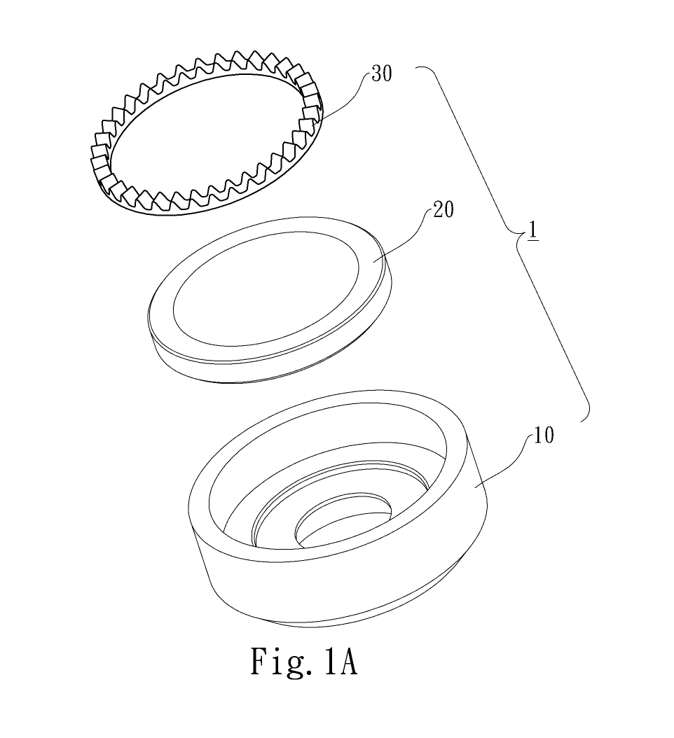

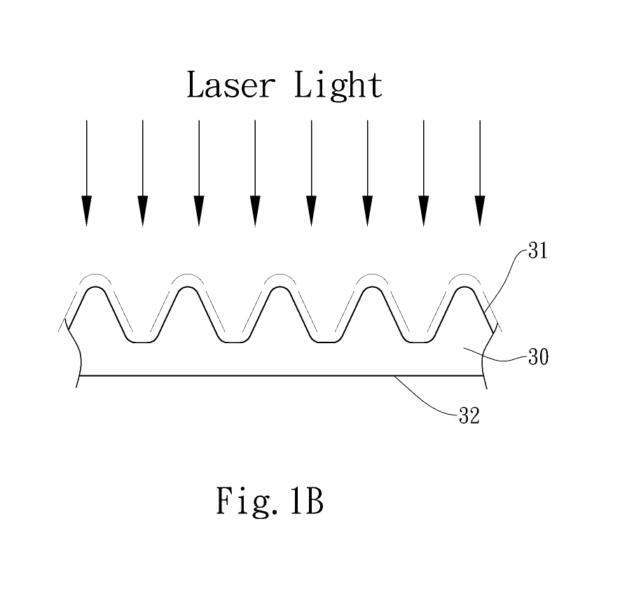

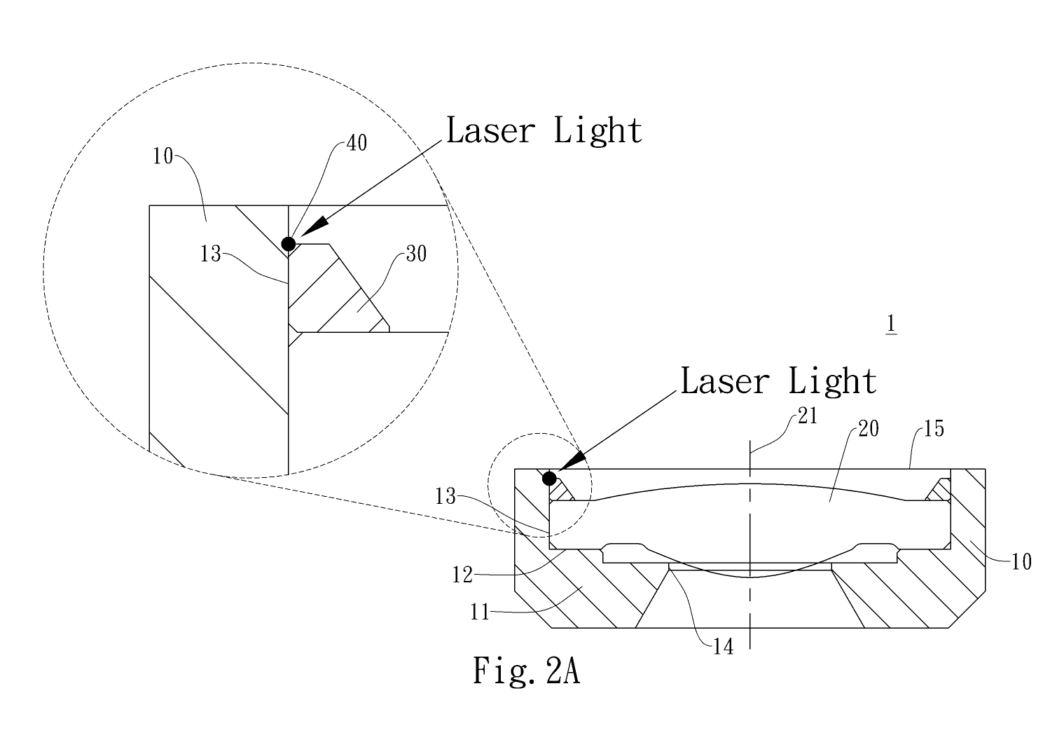

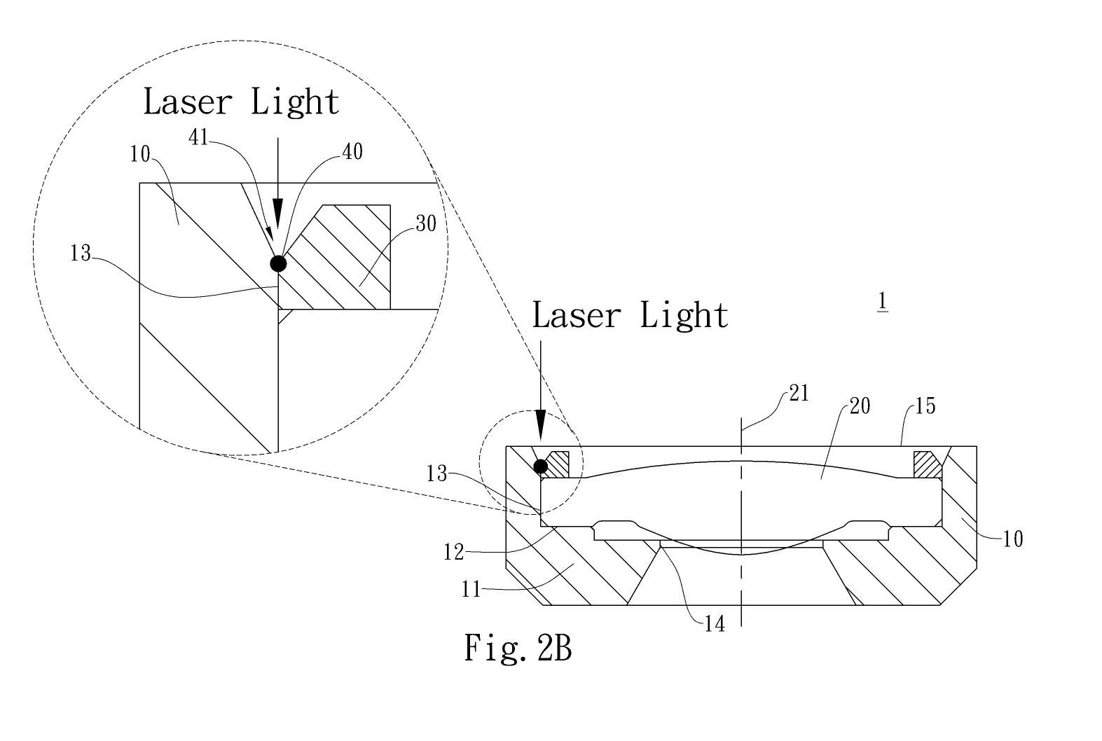

An optical lens assembly 1 of a first embodiment of the present invention will be described by reference to FIG. 1A illustrating an exploded view of the optical lens assembly 1. FIG. 1B is an enlarged partial view of a retainer shown in FIG. 1A. FIG. 2A illustrates a sectional view and an enlarged partial view of the optical lens assembly 1 in accordance with the first embodiment of the present invention.

As shown in FIG. 1A, the optical lens assembly 1 comprises a lens barrel 10, an optical lens 20 and a retainer 30. Regarding the lens barrel 10, e.g. a barrel-shaped member made of black plastic material, a lens holder, a CCD, a CMOS sensor or other image-displaying devices (not shown) can be connected to its outer side. Referring to FIG. 2A, the lens barrel 10 is hollow and comprises an inner side wall 13 and a base portion 11 formed at the bottom thereof. Moreover, a lens barrel opening 15 is defined at the top of the lens barrel 10. The base portion 11 has a center opening 14 and a horizontal top portion 12. The lens barrel opening 15 and the center opening 14 are arranged at opposite positions to form a light path through which light is projected to the CCD and/or CMOS sensor. To assemble the optical lens assembly 1, the first step is to place the optical lens 20 inside the lens barrel 10 with a bottom side of the optical lens 20 abutting against the horizontal top portion 12 of the base portion 11 and an optical axis 21 of the optical lens 20 aligned with a central axis line of the lens barrel 10.

Next, the retainer 30 comprising an energy receiving surface 31 and a horizontal bottom surface 32 is placed inside the lens barrel 10. In this embodiment, the horizontal bottom surface 32 is pressed against an image-side surface of the optical lens 20, and an interface between the retainer 30 and the inner side wall 13 of the lens barrel 10 serves as a welding area. Preferably, the energy receiving surface 31 of the retainer 30 has, for example, a serrated shape, as shown in FIG. 1B, so as to increase the surface area of the energy receiving surface. Optionally, the energy receiving surface 31 may have an undulating shape (not shown) that can also increase the surface area of the energy receiving surface.

Next, a laser welding method for the optical lens assembly 1 will be described by reference to FIG. 2A. After the optical lens 20 and the fixing lens 30 have been placed inside the lens barrel 10, a laser beam generated by a laser oscillator (not shown) is emitted to the welding area between the retainer 30 and the lens barrel 10 from an emitting unit (not shown). The welding area is an interface between the fixing lens 30 and the inner side of the lens barrel 10. As the laser beam is characterized by a high peak rate, it causes the welding area to deform slightly to form a welding point 40. The laser beam then irradiates other parts of the welding area to form a plurality of welding points 40 arranged in a circle between the retainer 30 and the lens barrel 10, thereby the combination of the retainer 30 and the lens barrel 10 can be reinforced. Preferably, the optical lens assembly 1 is rotated through a clamping means and a rotating means (not shown) while being irradiated by a laser beam so that the laser beam can irradiate the periphery of the retainer 30 in a continuous manner to form a plurality of welding points arranged in a circle. The energy receiving surface 31 of the retainer 30 is particularly configured to be of an undulating shape so that more laser energy can be received, thereby facilitating the temperature of the material irradiated by the laser beam reaching a welding temperature rapidly to accelerate the manufacturing process.

FIG. 2B illustrates an alternative example of the first embodiment. In this example, the retainer 30 has an oblique plane formed with respect to the inner side wall 13 of the lens barrel 10, and the inner side wall 13 of the lens barrel 10 has an oblique inner side wall formed with respect to the oblique plane, thereby a chamfer 41 is formed between the retainer 30 and the lens barrel 10 to serve as a welding area. The laser beam is emitted to the chamfer 41 from an emitting unit (not shown) to form a welding point 40 in the chamfer 41 so that laser beams can be emitted to the welding area from more than one directions to facilitate the manufacturing process.

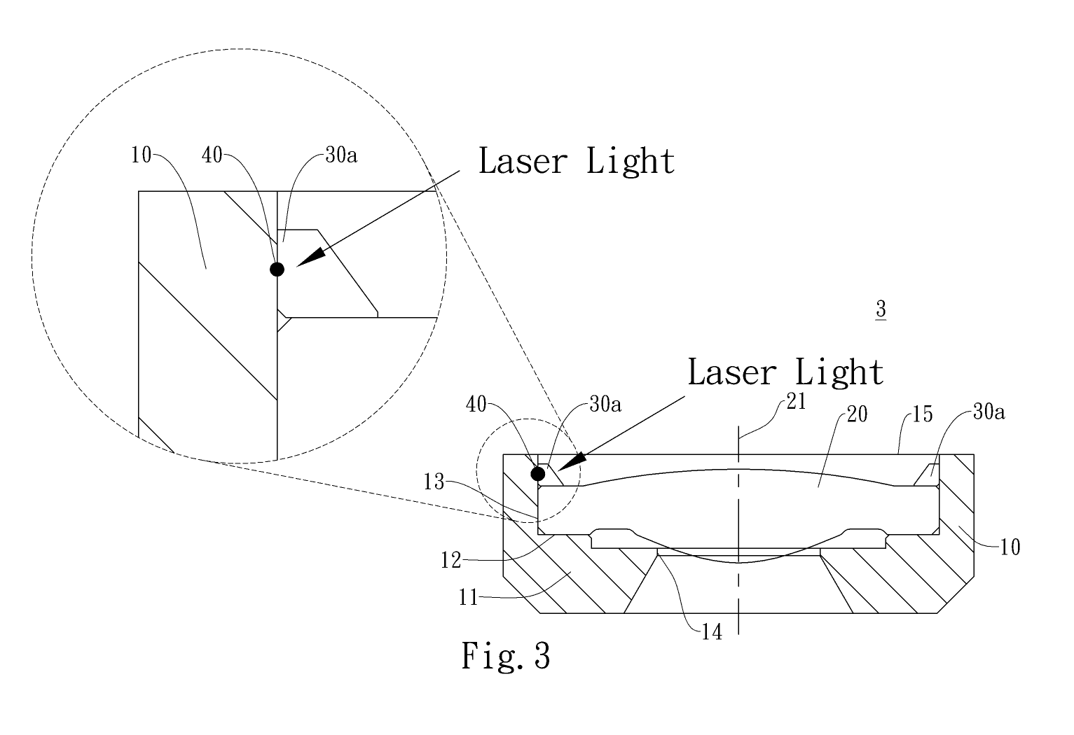

An optical lens assembly 3 of a second embodiment of the present invention will be described by reference to FIG. 3 illustrating a sectional view of the optical lens assembly 3. In FIG. 3, the optical lens assembly 3 comprises a lens barrel 10, an optical lens 20 and a retainer 30a and is characterized in that the retainer 30a is made of an infrared penetrable material selected particularly from light penetrable materials with good thermo-mechanical impact resistance, such as borosilicate crown glass (BK7), UV grade fused silicate glass, magnesium fluoride (MgF2), etc. The components of the optical lens assembly 3 are the same as the corresponding components of the optical lens assembly 1 of the first embodiment, except for the retainer 30a.

When a laser beam (e.g. an infrared laser beam) irradiates a surface of the retainer 30a, the energy of the laser beam penetrates the retainer 30a and accumulates in the area where the retainer 30a is in contact with the inner side of the lens barrel 10, thereby the temperature at the area increases and causes the retainer 30a to be welded to the inner side of the lens barrel 10. With the aforementioned arrangement, the size of the area where the retainer 30a and the lens barrel 10 are welded together is increased and the laser beam can be projected to the surface of the retainer 30a from any direction.

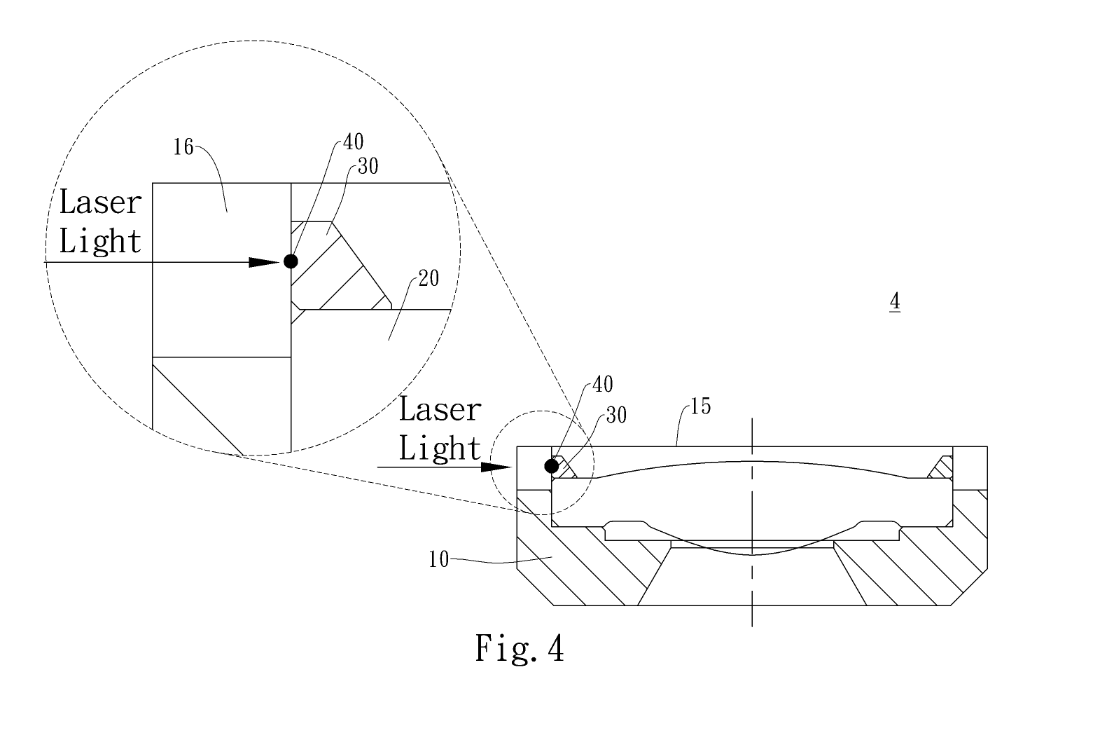

An optical lens assembly 4 of a third embodiment of the present invention will be described by reference to FIG. 4 illustrating a sectional view and an enlarged partial view of the optical lens assembly 4. In FIG. 4, the optical lens assembly 4 comprises a lens barrel 10, an optical lens 20 and a retainer 30. As the components of the optical lens assembly 4 are the same as those shown in FIG. 1 and FIG. 2A, no further description will be provided. The lens barrel 10 further comprises an infrared passable portion 16. The infrared passable portion 16 is ring-shaped and positioned near a lens barrel opening 15. The infrared passable portion 16 is made of an infrared penetrable material selected from a group of light penetrable materials with good thermo-mechanical impact resistance, such as borosilicate crown glass (BK7), UV grade fused silicate glass, MgF2, etc. The retainer 30 abuts against the infrared passable portion 16 of the lens barrel 10. When a laser beam (e.g. an infrared laser beam) irradiates the infrared passable portion 16 of the lens barrel 10, the energy of the laser beam will not accumulate on the lens barrel 10. Instead the energy accumulates on an interface between the inner side of the lens barrel 10 and the retainer 30 to weld the retainer 30 to the inner side of the lens barrel 10. The components of the optical lens assembly 4 are the same as the corresponding components of the optical lens assembly 1 of the first embodiment except that the lens barrel 10 comprises an infrared passable portion 16.

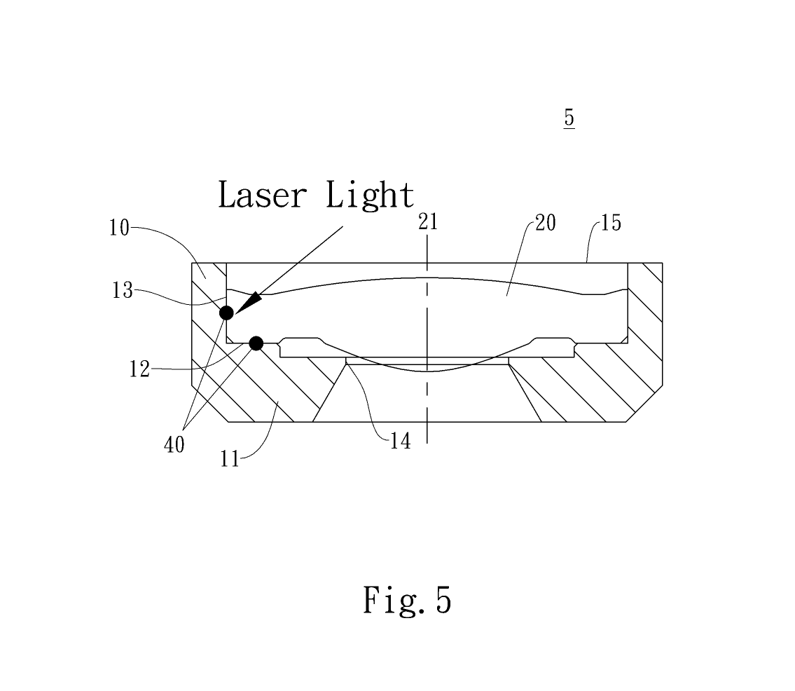

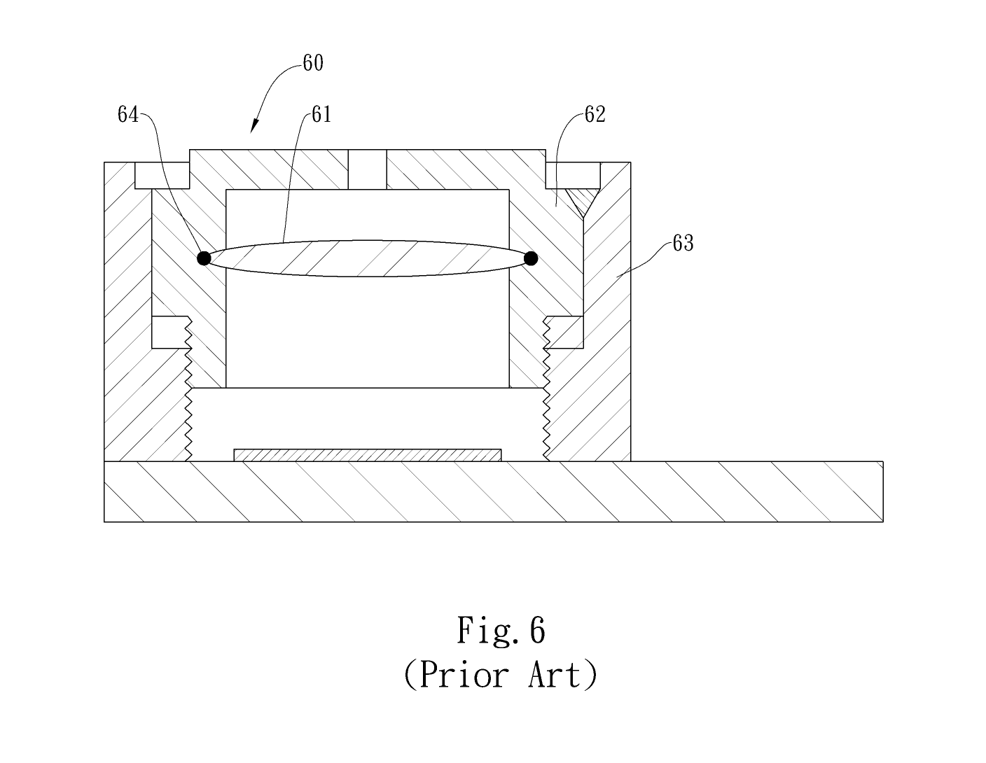

An optical lens assembly 5 of a fourth embodiment of the present invention will be described by reference to FIG. 5 illustrating a sectional view of the optical lens assembly 5. In FIG. 5, the optical lens assembly 5 comprises a lens barrel 10 and an optical lens 20. As the constituent parts of the lens barrel 10 and the optical lens 20 are the same as those shown in FIGS. 1-2A, no further description will be provided. A surface of the optical lens 20 abuts against the horizontal top portion 12 of the lens barrel 10. In this embodiment, an object-side surface of the optical lens 20 abuts against the horizontal top portion 12 and an optical axis 21 of the optical lens 20 is aligned with a central axis line of the lens barrel 10. A laser beam generated by a laser oscillator (not shown) is emitted to a contact area between the optical lens 20 and the lens barrel 10 from an emitting unit (not shown). The high peak rate of the laser beam causes the surface of the area to deform slightly to form a welding point 40. With the aforementioned arrangement, a plurality of welding points 40 can be formed in the area where the optical lens 20 is in contact with the lens barrel 10, thereby welding the optical lens 20 to the lens barrel 10.

While this invention has been described by way of preferred embodiments, those skilled in the art will understand that various alterations can be made herein without departing from the spirit and scope of this invention.

What is claimed is:

1. An optical lens assembly, comprising: at least one optical lens, a lens barrel and a retainer, wherein the optical lens and the retainer are disposed within the lens barrel in a manner that the optical lens is arranged between the retainer and the lens barrel; and wherein at least one welding point is formed between the retainer and the lens barrel by laser.

2. The optical lens assembly according to claim 1, wherein at least one welding point arranged in a circular fashion is formed between the retainer and the lens barrel.

3. The optical lens assembly according to claim 1, wherein the retainer and the lens barrel are made of plastic material in black.

4. The optical lens assembly according to claim 1, wherein the retainer further comprises an energy receiving surface having a serrated or undulating shape.

5. The optical lens assembly according to claim 1, wherein the retainer is made of an infrared passable material.

6. The optical lens assembly according to claim 1, wherein the lens barrel further comprises an infrared passable portion which is in contact with the retainer.

7. The optical lens assembly according to claim 1 further comprising a chamfer formed between the lens barrel and the retainer.

8. An optical lens assembly, comprising: at least one optical lens and a lens barrel, wherein the optical lens is disposed within the lens barrel and an outer periphery thereof is laser welded to an inner wall of the lens barrel, and wherein at least one welding point is formed between the optical lens and the lens barrel.

9. The optical lens assembly according to claim 8, wherein at least one welding point arranged in a circular fashion is formed between the optical lens and the lens barrel.

10. A laser welding method for an optical lens assembly, comprising steps:
providing a lens barrel, an optical lens and a retainer;
placing the optical lens within the lens barrel with an optical axis of the optical lens aligned with a central axis of the lens barrel;
placing the retainer within the lens barrel and pressing the retainer against a side surface of the optical lens; and
irradiating the retainer with a laser beam to weld the retainer to an inner side of the lens barrel.

11. The method according to claim 10, wherein a chamfer is further formed between the lens barrel and the retainer with the laser beam being emitted to the chamfer.

12. The method according to claim 10, wherein the retainer is made of an infrared passable material.

13. The method according to claim 10, wherein the lens barrel further comprises an infrared passable portion positioned corresponding to the retainer.

14. A laser welding method for an optical lens assembly, comprising steps:
providing a lens barrel and an optical lens;
placing the optical lens within the lens barrel with an optical axis of the optical lens aligned with a central axis of the lens barrel; and
irradiating an area where the optical lens is in contact with the lens barrel by a laser beam so as to weld the optical lens to the lens barrel.
